(19) United States
(12) Patent Application Publication
(10) Pub. No.: US 2017/0143114 A1
(43) Pub. Date: May 25, 2017

(54) STANDING CLIPBOARD

(71) Applicant: Joana BRAVO RUBIES, Lleida (ES)

(72) Inventor: Joana BRAVO RUBIES, Lleida (ES)

(21) Appl. No.: 15/173,688

(22) Filed: Jun. 5, 2016

(30) Foreign Application Priority Data
Nov. 23, 2015 (ES) ES201500793U

(51) Int. Cl. A47B 23/04; B42F 9/00

(52) U.S. Cl. CPC A47B 23/042; B42F 9/001

(57) ABSTRACT

A standing clipboard comprising a board that is fixed along one of its edges to a base, and on an opposite edge there is a manual clip that can be used to safely and reliably hold paper in place, regardless of size. Notes can be removed by simply pushing on the clip. The board can be placed vertically or at an angle without affecting the essence of the invention. Both the board that holds the notes in place and the base can be made from any kind of suitable material, including wood, aluminium, plastic, methacrylate, etc. The invention is a highly effective, simple, and practical standing clipboard that can be used alongside, for example, a computer and/or a phone.

### CROSS-REFERENCE TO RELATED APPLICATION

This application claims the priority filing date of SPANISH PATENT AND TRADEMARK OFFICE application number ES201500793U filed on Nov. 23, 2015 in the name of Joana Bravo Rubies. The earliest priority date claimed is Nov. 23, 2015.

### FEDERALLY SPONSORED RESEARCH

None

### SEQUENCE LISTING OR PROGRAM

None

### BACKGROUND

This invention is a standing clipboard, whose purpose is to construct a means by which sheets of paper can be held in place. Any kind of message, including a phone message or any other information that need to be visible and remembered, for example, in an office, can be written on the paper and placed on the standing clipboard.

The invention is intended for environments, such as offices and similar spaces, where it is common to receive multiple incoming calls, or make notes on small pieces of paper. These can easily be lost, and problematic, especially if the information is important.

Attempts to solve this problem include notepads, some of which have a sticky strip along one end in order to stick the note on a visible location. Though these devices fulfill the function for which they were designed, they have to be replaced constantly, which can be costly. Moreover, due to their size, they are not always suitable for writing down lengthy information. Also, there is a risk that the note could become stuck to the surface on which it was placed.

The object of the invention is to provide a standing clipboard for making notes that will remain visible and accessible, that is easy to use, structurally simple, and inexpensive.

### SUMMARY

The standing clipboard recommended here solves the problem described above, based on a simple but extremely effective structure.

More specifically, the invention comprises a board that is fixed along one of its edges to a base, and on the opposite edge there is a manual clip that can be used to safely and reliably hold paper in place, regardless of the size. The notes can be removed by simply pushing on the clip.

The board can be placed vertically or at an angle without affecting the essence of the invention.

Both the board that holds the notes in place and the base can be made from any kind of suitable material, including wood, aluminium, plastic, methacrylate, etc.

The invention is a highly effective, simple, and practical standing clipboard that can be used alongside, for example, a computer and/or a phone.

### DRAWINGS

In order to complement the description below and to facilitate a better understanding of the characteristics of the invention, as well as display the preferred embodiment of the invention, a drawing is attached, which is an integral part of the description, for the purposes of illustration only, showing the following:

FIG. 1: Shows a front-view of the standing clipboard carried out in accordance with the object of this invention.

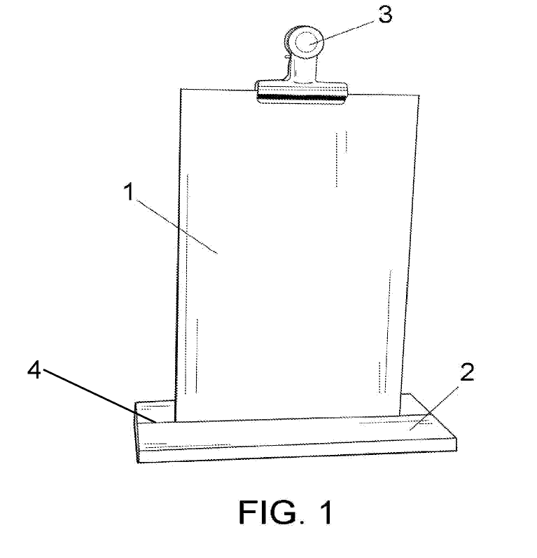

### DESCRIPTION OF THE PREFERRED EMBODIMENT

As can be seen in the figure below, the invention comprises a board (1), which in the example is rectangular, but may also be of a different shape. The board (1) is supported vertically on a base (2), though it could also be at an angle, and the whole invention would stand on a table, desk, or any other suitable surface.

The board (1), on its edge opposite to the one attached to the base (2), has a clip (3), which can be opened manually, and can be used to hold papers and notes. These notes would rest on the surface of the board (1), and the clip (3) can be opened to release and reattach any pieces of paper or notes, etc.

Evidently, the base (2), which could be made of the same material as the board (1) or of a different material, can have other shapes than the rectangular shape shown in the figure, as long as it serves to support the board (1).

What is claimed:

1. A standing clipboard comprising a board attached on one end to a base containing a fissure into which the board is inserted and that provides support, and on another end a manual clip is disposed to hold notes in place.

2. The standing clipboard according to claim 1, wherein the shape of the board is rectangular.

3. The standing clipboard according to claim 1, wherein the board, as a support for notes, is arranged vertically in relation to the base.

4. The standing clipboard according to claim 1, wherein the board, as a support for notes, is arranged at an angle in relation to the base.
